(19) United States
(12) Patent Application Publication
(10) Pub. No.: US 2007/0044908 A1
(43) Pub. Date: Mar. 1, 2007

(54) Method of Forming Spacers on a Substrate

(75) Inventors: Ching-Hsiang Chan, Hsinchu Hsien (TW); Liang-Ying Huang, Hsinchu Hsien (TW); Cheng-Chung Lee, Hsinchu Hsien (TW); Jia-Chong Ho, Hsinchu Hsien (TW); Ming-Chun Hsiao, Hsinchu Hsien (TW)

Correspondence Address: LOWE HAUPTMAN BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Chutung Town (TW)

(21) Appl. No.: 11/552,003

(22) Filed: Oct. 23, 2006

Related U.S. Application Data
(62) Division of application No. 10/645,616, filed on Aug. 22, 2003.

(30) Foreign Application Priority Data
Jun. 24, 2003 (TW) 92117180

(51) Int. Cl. B32B 37/00

(52) U.S. Cl. 156/297

(57) ABSTRACT

A method of forming spacers on a display substrate is described. First, a mould having a plurality of trenches is provided. Spacer are dropped onto the mould. When the mould is vibrated, the spacers fall into the trenches. Then, a display substrate having viscous substance on a surface thereof is pressed onto the spacers in the trenches of the mould, so that the spacers are bonded to the display substrate due to the viscous substance. Finally, the spacers bonded with the display substrate are removed from the trenches of the mould.

### RELATED APPLICATIONS

This application is a divisional of U.S. application Ser. No. 10/645,616, filed on Aug. 22, 2003, which claims priority to Taiwan Application Serial Number 92117180, filed Jun. 24, 2003, hereby incorporated by reference as it fully set forth herein.

### FIELD OF THE INVENTION

The present invention relates to a manufacturing method of a flat panel display, and especially to a method of forming spacers on a substrate.

### BACKGROUND OF THE INVENTION

User demand for entertainment equipment is particularly high as a result of the rapid development of multimedia applications. Conventionally, the cathode ray tube (CRT) display, which is a type of monitor, is commonly used. However, the cathode ray tube display does not meet the needs of multimedia technology because of the large volume thereof. Therefore, many flat panel display techniques such as liquid crystal display (LCD), plasma display panel (PDP), and field emission display (FED) have been recently developed.

The luminescence method adopted by the field emission display (FED) is same as the cathode ray tube (CRT) display. The field emitted electrons are attracted out of the cathode plate and accelerated to hit the fluorescent material of the anode plate, causing luminescence. The FED has the advantages of the CRT display. Additionally, the panel in the FED is thick. Moreover, In comparison with the LCD, the FED has a higher response velocity, a wider view angle, a preferred luminescent efficiency and a better display result. On the other hand, it is not necessary to use z back light in the FED even when displaying outside.

The structure of a field emission display (FED) includes the cathode plate and anode plate. A vacuum state exists between the two plates. One of the two plated is the ITO glass substrate. A fluorescent material is coated over this substrate. The other plate is composed of the field emitting arrays. Each pixel of the FED has a corresponding field emitting array. When operating, a discharge happens in the cathode when applying a low gate voltage to the cathode. The emitted electrons are accelerated by the anode and hit the fluorescent material of the anode plate, causing luminescence. The fluorescent material is a phosphor.

After all processes for these two plates are finished, these two plates can be adhered together. Then, an exhausting process must be performed to achieve a degree of vacuum lower than the 10⁻⁶ torr between the two plates. This ensures that the field emitting electrons are not affected by the residual gas thereof. However, when a high vacuum exists between the two plates, the pressure difference can cause a non-uniform distance between the two plates, which influences the luminescent efficiency. Therefore, spacers are located between the two plates to ensure a uniform distance between them. However, the places where these spacers may be located on the plate is limited to avoid covering the fluorescent material and affecting the luminescent efficiency. In other words, the spacers must be located on the black matrix layer between the pixels. Moreover, the thickness of the spacer is about 1 mm.

Generally, a machine arm is used to arrange the spacers over the plate. However, the conventional arrangement method easily breaks the spacers. Moreover, it is also difficult to achieve a precise alignment with the conventional method, which influences the yield. Therefore, how to increase the yield and how to protect the spacers during process are the most important problems that the engineers have to solve.

### SUMMARY OF THE INVENTION

Because the development trend for panels is toward large size, the key point for increasing the yield is to reduce the process time. The main object of the present invention is to provide a method for forming spacers on a substrate. An auxiliary trench structure is added to assist spacer arrangement on the substrate.

According to the above object, the present invention provides a method for forming spacers comprising the following steps. First, a mould is provided. A plurality of trenches is formed on the surface of this mould. Next, a plurality of spacers is located on the surface of this mould. Then, the mould is vibrated to make these spacers respectively fall into corresponding trenches. After that, a viscous substance is coated over the substrate of the display. Then, the substrate is adhered to the mould so that the spacers on the mould can be adhered on the substrate. Finally, the spacers are removed from the mould.

The method of locating the spacers on the mould can use fluid to place the spacers or use a direct spraying method. Moreover, according to the preferred embodiment, when the spacers fall into the trenches, a UV light fixing method or static electricity fixing method is used to temporarily fix these spacers on the trenches. Generally, the spacer is cruciform or rectangular. On the other hand, the length of the side of the trench can be modified. For example, cruciform spacers are arranged in an “X” type shape to withstand the corner of a square trench. Such arrangement can control the direction of the spacers. Moreover, an additional bulge can also be located in the trench to control the direction of the spacers. Moreover, the open area in a preferred trench structure is larger than the bottom area. Such a structure with inclined sidewalls can help the spacer fall into the trench.

The method of the present invention can reduce the process time for forming the spacers and reduce the possibility of breaking the spacers.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 to FIG. 4 illustrate the manufacturing method for forming the spacers on the substrate in accordance with the preferred embodiment;

FIG. 5A is a schematic view of a rectangular spacer in accordance with the preferred embodiment;

FIG. 5B is a schematic view of spacer in accordance with the preferred embodiment;

FIG. 6A is a schematic top view of the trench in accordance with the preferred embodiment;

FIG. 6B is a schematic cross-sectional view of the trench in accordance with the preferred embodiment;

FIG. 7 is a schematic diagram of a cruciform spacer after having fallen into the trench;

FIG. 8 is a schematic diagram of a cruciform spacer that cannot fall into the trench; and

FIG. 9 is a schematic diagram of a trench in accordance with another preferred embodiment.

### DETAILED DESCRIPTION OF THE PREFERRED EMBODIMENT

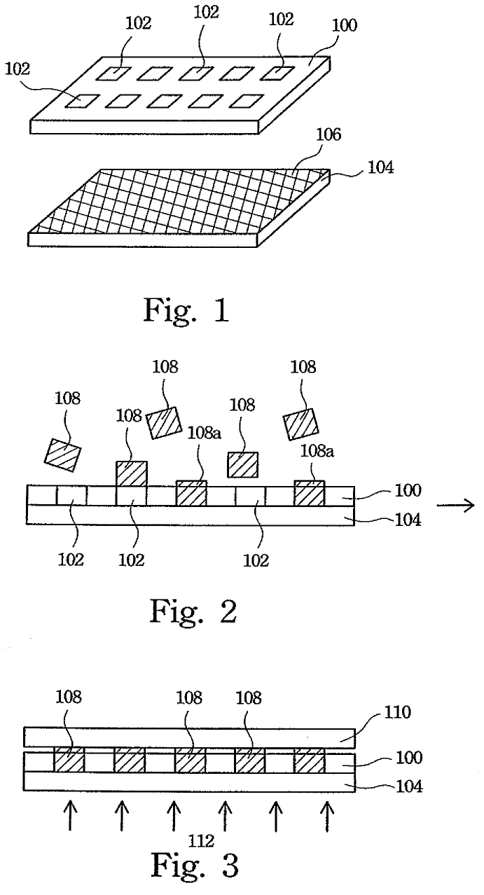

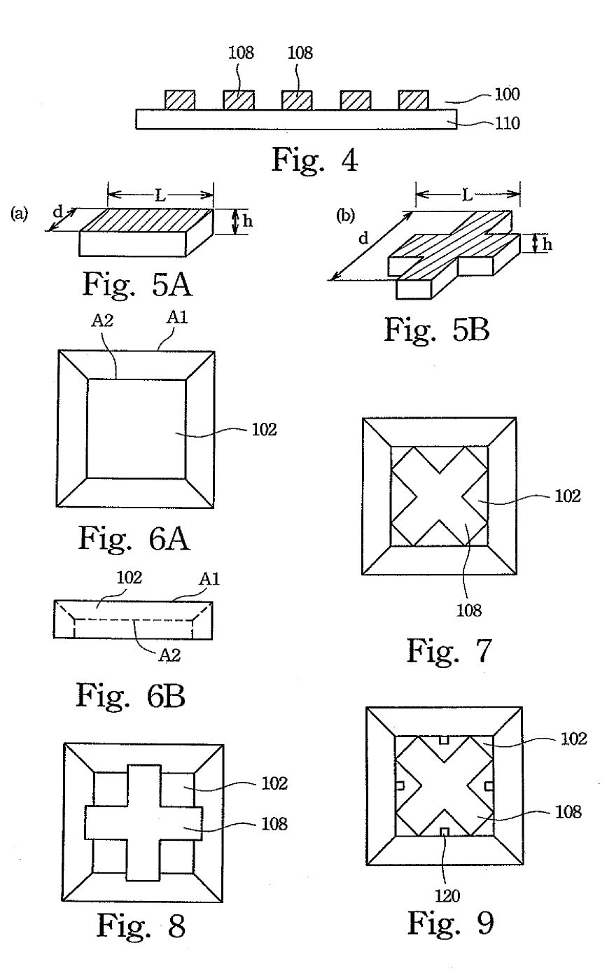

FIG. 1 to FIG. 4 illustrate the manufacturing method for forming the spacers on the substrate in accordance with the preferred embodiment.

Referring to FIG. 1, a mould 100 with a plurality of trenches 102 is formed first. These trenches 102 penetrate the mould 100. The number and the location of the trenches are related to the spacers. For example, the spacers have to be located on the black matrix between the pixels. Therefore, the distance between the trenches is equal to the distance between the pixels.

Moreover, an auxiliary substrate 1 04 is provided. A viscous substance 106 is coated on the auxiliary substrate 104. It is noted that this auxiliary substrate 104 is not the substrate used in the FED. Next, the substrate 104 and the mould 100 are adhered together. The penetrated trenches 102 expose some viscous substance 106.

Referring to FIG. 2, after the substrate 104 and the mould 100 are adhered together, a plurality of spacers 108 are located on the non-adhered surface of the mould 100. Then, the substrate 104 and the mould 100 are vibrated, the arrow in the FIG. 2 indicating the vibrated direction, to make these spacers 108 respectively fall into corresponding trench 102 due to the vibration. These spacers 108 can be temporary fixed in the trenches 102 by the exposed viscous substance 106, as exemplified by spacer 108a in FIG. 2.

There are two methods for locating the spacers 108 on the mould 100. One is to use the fluid to bring the spacers 108 to the mould 100. The other is to directly spray the spacers 108 on the mould 100. The number of spacers 108 located on the mould 100 can be larger the number of the trenches 102. In other words, the number of the spacers 108 is larger than the required number of the spacers. Therefore, the probability of spacers 108 falling into the trenches 1 02 can be increased. The process time of this step also can be reduced. However, the above description does not limit the present invention.

Referring to FIG. 3, glue (not shown in the figure) is coated on the substrate 110. Substrate 110 is the substrate of the FED. After coating the glue on the substrate 110, the substrate 110 is adhered to the mould 100 so that the substrate 110 contacts the spacers 108. Such contact adheres the spacers 108 and the substrate 110 together due to the glue. The area coated with glue can include the entire substrate or only the locations for forming the spacers.

Next, an UV light 112 is used to illuminate the viscous substance 106 on the substrate 104. The preferred illuminating direction is from the non-adhered side of the substrate 104. After the UV light illuminates the viscous substance 106, the viscous substance 106 is no longer sticky. Therefore, the spacers 108 are only adhered to the substrate 110. When the substrate 110 is removed from the mould 100, the spacers 108 are also removed from the trenches. After that, the substrate 110 with the spacers 108 is finished.

The main object of using viscous substance 106 in the present invention is to utilize the temporary adhesive characteristic thereof. The temporary adhesive temporarily adheres the spacers to the trenches to prevent the spacers from escaping the trenches due to vibration. Moreover, after the UV light illuminates the viscous substance 106, the viscous substance 106 loses its adhesive characteristic. Therefore, the spacers are easily removed from the auxiliary substrate. It is noted that any temporary adhesive apparatus can be used in the present invention. For example, a static electricity fixing method also can be used in the present invention to fix temporarily the spacers. When the static electricity fixing method is used in the present invention, it is not necessary to form trenches that penetrate the auxiliary substrate. In other words, the temporary fixing apparatus can simplify the FED process. However, if the vibration apparatus of the mould is modulation, the temporary fixing apparatus also can be removed.

On the other hand, the main purpose of using the glue in the present invention is to utilize its characteristic of permanent fixing. The glue can be composed of glass powder. However, other fixing element having a permanent fixing characteristic also can be used in the present invention.

A transparent material can be used to manufacture the auxiliary substrate in the present invention. A transparent substrate is easily aligned with the mould. Moreover, a glass material can be used to form the spacers. The auxiliary substrate can be formed by a plastic injection moulding technology or a quick moulding technology.

The spacers can have different appearance. Generally, the spacers have a symmetrical appearance. FIG. 5A is a schematic view of a rectangular spacer in accordance with the preferred embodiment. FIG. 5B is a schematic view of a cruciform spacer in accordance with the preferred embodiment. The spacer preferably has a height “h” that is less than the width “d” and the length “L”, as shown in FIG. 5A and FIG. 5B. Such dimensions can increase the stability of the spacer. In other words, the spacer has a larger bottom area as shown by the oblique line in the FIG. 5A and 5B. The larger bottom area is adhered to the substrate in the FED. Generally, a conventional spacer can be used in the present invention.

The spacers can fall into the trenches by a vibration process. Generally, the adhesive force of the viscous substance is weak. Therefore, when the larger bottom area of the spacer does not contact the auxiliary substrate, the spacer is not fixed on the auxiliary substrate by the viscous substance. In other words, the spacer is vibrated again until the larger bottom area of the spacer contacts the auxiliary substrate. At this time, the adhesion between the spacer and the auxiliary substrate resists the vibration process. Therefore, the spacer can be fixed on the auxiliary substrate.

The probability of the spacers falling into the trenches and the way the spacers are arranged in the trenches can be decided by the shape of the trenches.

FIG. 6A is a schematic top view of the trench in accordance with the preferred embodiment. FIG. 6B is a schematic cross-sectional view of the trench in accordance with the preferred embodiment. In accordance with the FIG. 6A, the trench is preferably tapered. The trench has two open areas. The top open area of the trench is A1 and the bottom open area is A2 as shown in the FIG. 6A. Four sidewalls forming the top opening are inclined toward the inside to form the bottom opening. Another four sidewalls from the bottom opening are perpendicularly expanded. Therefore, the top open area Al is larger than the bottom open area A2. The larger top open area Al encourages the spacer to fall into the trench. Additionally, the inclined sidewalls from the top opening can further help the spacers enter the trench through the bottom opening. No matter what the shape of the spacer is, such a trench design encourages the spacer to fall easily into the trench. It is noted that as long as the top open area is larger than the bottom open area, inclined sidewalls can be obtained.

In accordance with the preferred embodiment, if a rectangular spacer is used, a trench with a rectangular shape can be used to ensure that only a rectangular shape spacer can fall therein. On the other hand, if a cruciform spacer is used, in addition to a cruciform trench, a trench as shown in FIG. 7 can also be used. FIG. 7 is a schematic diagram of a cruciform spacer having fallen into the trench. Due to the diagonal length being larger than the side length in a square trench 102, the trench 102 can be designed to make the spacer 108 be arranged in an “X” when the spacer 108 falls into the trench 102. In other words, it is impossible for any other arrangement of the spacer 108 in the trench 102 to occur. FIG. 8 illustrates a schematic diagram of a cruciform spacer 108 that cannot fall into the trench 102. A vibration process is performed to change the orientation of spacer 108 and allow the same to fall into the trench 102. In other words, the arrangement of the spacer 108 in the trench 102 can be controlled by the design of the trench 102.

FIG. 9 is a schematic diagram of the trench in accordance with another preferred embodiment. Referring to FIG. 9, bulges 120 are assembled into the trench 102. The function of the bulge 120 is to control the arrangement of the spacers 108 in the substrate. Because the bulges 120 can reduce the width and the length of the opening, such structure can avoid incorrect arrangement of the spacers 108 in the trench 102.

The above method can be used in a Carbon Nanotube Field Emission Display, CNT-FED. It is noted that the above manufacturing method also can be used in other displays.

According to the method of the present invention, the bond between the substrate and the spacer can be accomplished only by the mould and the auxiliary substrate. Therefore, the method can reduce the process time for forming the spacers and reduce the possibility of breaking the spacers. Moreover, the auxiliary substrate can be formed by a plastic injection moulding. In comparison with the conventional machine arm arrangement, this method is cheaper.

As is understood by a person skilled in the art, the foregoing preferred embodiment of the present invention is illustrative rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for forming spacers on a substrate, said method comprising the following steps of:
providing a mould with a plurality of trenches;
locating a plurality of spacers on said mould, wherein a spraying method is used to locate said spacers on said mould;
vibrating said mould to make said spacers fall into said trenches;
coating a glue on a first substrate;
bringing said first substrate into contact with said mould to make said spacers adhere to said first substrate; and
removing said spacers from said trenches.

2. The method of claim 1, wherein said method further comprises temporarily fixing said spacers in said trenches when said spacers fall into said trenches.

3. The method of claim 2, wherein said trenches penetrate said mould.

4. The method of claim 3, further comprising providing a second substrate, wherein said second substrate is brought into contact with said mould and a viscous substance is formed on said second substrate for temporarily fixing said spacers when said spacers fall into said trenches.

5. The method of claim 4, wherein said viscous substance is neutralized by UV light.

6. The method of claim 5, wherein said method further comprises using a UV light to illuminate said second substrate to neutralize said viscous substance and then removing said spacers from said mould.

7. The method of claim 2, wherein said method further comprises providing a static electricity fixing apparatus to fix said spacers having fallen into said trenches.

8. The method of claim 1, wherein the spacer is cruciform.

9. The method of claim 8, wherein said cruciform spacer is arranged in a diagonal of a trench.

10. The method of claim 1, wherein said spacer is rectangular.

11. The method of claim 1, wherein an open area of said trench is larger than a bottom area of said trench.

12. The method of claim 1, wherein said trench further comprises at least a bulge.

13. A method for forming spacers on a substrate, said method comprising the following steps of:
forming a plurality of trenches in a mould, wherein said trenches penetrate said mould;
coating a viscous substance on a first substrate, wherein said viscous substance is neutralized by UV light;
bonding said first substrate to said mould, wherein said trenches on said mould partially expose said viscous substance;
locating a plurality of spacers on said mould, wherein a spraying method is used to locate said spacers on said mould;
vibrating said mould to make said spacers fall into said trenches, wherein said spacers are temporarily fixed in said trenches by said viscous substance;
coating a glue on a second substrate;
brining said second substrate into contact with said mould to make said spacers adhere to said second substrate; and
removing said spacers from said trenches.

14. The method of claim 13, wherein said spacer is cruciform.

15. The method of claim 14, wherein said cruciform spacer is arranged in a diagonal of a trench.

16. The method of claim 1 3, wherein said spacer is rectangular.

17. The method of claim 13, wherein an open area of said trench is larger than a bottom area of said trench.

18. The method of claim 13, wherein said trench further comprises at least a bulge.
